(19) United States
(12) Patent Application Publication
(10) Pub. No.: US 2026/0103383 A1
(43) Pub. Date: Apr. 16, 2026

(54) HYBRID GRAPHENE COMPOSITE PARTICLES

(71) Applicant: BIOGENESYS INC., Seoul (KR)

(72) Inventor: Joon Sub SHIM, Yongin-si (KR)

(21) Appl. No.: 19/116,147

(22) PCT Filed: Jun. 19, 2023
(86) PCT No.: PCT/KR2023/008474

§ 371 Date: Oct. 7, 2025

(30) Foreign Application Priority Data
Sep. 27, 2022 (KR) 10-2022-0122801
Jan. 30, 2023 (KR) 10-2023-0011559

(51) Int. Cl. C01B 32/194

(52) U.S. Cl. CPC C01B 32/194; C01B 2204/22; C01B 2204/32; C01P 2002/30; C01P 2004/03; C01P 2006/40

(57) ABSTRACT

Provided is hybrid graphene composite particles comprising: a graphene composite in which a plurality of primary microparticles and multilayer graphene are mixed; and secondary microparticles encompassed by or coated with the graphene composite, wherein the primary microparticles are bound to the surface or the inside of the multilayer graphene, and some empty spaces between the primary microparticles are filled with the graphene composite such that a connected structure is formed.

### TECHNICAL FIELD

The present disclosure relates to hybrid graphene composite particles, and more particularly, to a graphene-based composite material (hybrid graphene) that may be used as negative and positive electrode active materials.

### BACKGROUND ART

There are various secondary batteries that are rechargeable, such as lead-acid batteries and nickel-metal hydride batteries, but even among them, a lithium-ion battery (LIB) has been not only used as batteries to supply power to portable mobile devices such as smart phones and net books, but also widely used as an energy supply member and the like to supply energy to hybrid vehicles, etc., due to high energy density, high power density, operating voltage that may withstand long charge and discharge, and the like.

In the LIB, a positive electrode active material is variously changed to improve its performance. However, even if high energy is generated from a positive electrode material, when a negative electrode material, as a space which stores the energy, is not balanced, the efficiency is inevitably decreased. In particular, only when the negative electrode material is manufactured to be able to receive lithium ions well during charging, the charge time may be reduced. Graphite has been widely used as a negative electrode active material for a long time. The graphite is a layered structure in which several layers of carbons bound in a regular form are laminated. During the charging process, in which lithium ions move from a positive electrode to a negative electrode, the lithium ions that reach the negative electrode are stored between graphite layers.

Currently, research has been conducted on new materials capable of replacing conventional negative electrode active materials to improve the performance of the lithium ion battery. The graphite has low electrical conductivity, so that the charge and discharge time is long, and the capacity for lithium ions to be bound is not sufficient, so that the charge capacity is not high.

In addition, porous carbon materials that exhibit excellent electrochemical performance have been mainly used as positive electrode materials for lithium batteries. As a specific example, Korean Patent Publication No. 10-2014-0110572 discloses a positive electrode for a lithium air battery, and more particularly, relates to a positive electrode for a lithium air battery including a catalyst layer including a first conductive material supported on a binder and a catalyst supported on a second conductive material; and a current collector. At this time, the first conductive material and the second conductive material are carbon materials, such as graphite, Denka black, and Ketjen black.

Currently, research has been conducted on new materials capable of replacing conventional positive electrode active materials to improve the performance of a lithium ion battery. The graphite has low electrical conductivity, so that the charge and discharge time is long, and the capacity for lithium ions to be bound is not sufficient, so that the charge capacity is not high.

Therefore, there is a need to develop new materials capable of increasing the charging capacity and battery life of the lithium ion battery, and shortening the charging time by solving or alleviating the problems to improve the characteristics of negative and positive electrode materials compared to the related art.

### DISCLOSURE

### Technical Problem

An object to be solved by the present disclosure is to solve the problem that graphite included in conventional negative and positive electrode active material layers in a lithium ion battery has low electrical conductivity, so that the charging and discharging time is long, and the capacity for lithium ions to be bound is not sufficient, so that the charging capacity is not high. To this end, there is provided hybrid graphene composite particles for a lithium ion battery including hybrid graphene having a graphene composite multilayer structure in which metal, semiconductor particles, and silicon are melt-bonded to graphene to form a three-dimensional network.

### Technical Solution

In order to overcome these problems, the present disclosure provides hybrid graphene composite particles in which metal or semiconductor particles are connected with multilayer graphene and secondary microparticles are encompassed by or coated therewith to form a network structure, so that the metal or semiconductor particles may be maintained in a stable state even when charging and discharging are repeated. In the related art, since a process of mixing graphene with the metal or semiconductor particles is a simple mixing process with pre-generated graphene, an organic bonding strength between the metal or semiconductor particles and graphene is lack.

In the present disclosure, since in the process of manufacturing graphene, the graphene is manufactured by mixing primary and secondary microparticles, the surfaces of the primary and secondary microparticles are molten and solidified with the graphene, so that the microparticles and graphene are bound to form a three-dimensional nanostructure.

In addition, since the formed hybrid graphene composite particles are composed of multilayer graphene, primary and secondary microparticles are bound to the surface or the inside of the multilayer graphene, and spaces between silicon microparticles are filled with the graphene composite so that a connected structure is formed.

As such, hybrid graphene composite particles, including a graphene composite having a structure in which a plurality of primary microparticles and multilayer graphene are mixed, and secondary microparticles encompassed by or coated with the graphene composite, have the following effects.

First, since the surfaces of the primary and secondary microparticles are completely coated with graphene, it is possible to effectively suppress the volume expansion that occurs when the microparticles are bound with lithium ions. As a result, it is possible to solve a problem of metal or semiconductor particles that are broken and separated from an electrode due to excessive volume expansion and contraction.

Second, the multilayer graphene serves as a scaffold to fix the positions of the primary and secondary microparticles. Theoretically, due to a tensile strength 200 times stronger than steel, the graphene is not easily broken even when bent or curved. Therefore, when the graphene is bound with the metal or semiconductor microparticles to form a multilayer structure, the positions of the metal or semiconductor microparticles are fixed, and thus the graphene serves as a scaffold that maintains a stable structure even in changes in shape of the metal or semiconductor due to charging and discharging.

Third, the graphene has high electron mobility and current density to facilitate electron transfer with lithium ions. As a result, the electron transfer with the metal or semiconductor microparticles is facilitated, thereby increasing the charge/discharge rate and improving the charge and discharge efficiency by the hybrid graphene composite particles.

In order to achieve the object, the present disclosure provides hybrid graphene composite particles including a graphene composite having a structure in which a plurality of primary microparticles and multilayer graphene are mixed, and secondary microparticles encompassed by or coated with the graphene composite, in which the primary microparticles are bound to the surface or the inside of the multilayer graphene, some of the primary microparticles are bound and solidified with each other, the multilayer graphene has a three-dimensional structure in which a plurality of layers of graphene are laminated and bent in an arbitrary direction, the graphene composite is produced by a photochemical, photothermal irradiation or heat treatment process, and some of empty spaces between the primary microparticles are filled with the graphene composite so that a connected structure is formed.

In addition, the primary microparticles may be metal or semiconductor particles.

In addition, while the surface of the primary microparticles is molten and solidified with graphene, the microparticles and graphene may form a three-dimensional nanostructure and be bonded to each other.

In addition, the primary microparticles may consist of metal or semiconductor selected from the group consisting of silver (Ag), silicon (Si), silicon carbide (Si₂C, SiC or SiCX including SiC₂), silicon oxide (SiOX including SiO or SiO₂), silicon composite oxide (Si—MgxSiOx), magnesium metasilicate (enstatite, MgSiO₃), forsterite (Mg₂SiO₄), gold (Au), platinum (Pt), palladium (Pd), aluminum (Al), zinc (Zn), silver alloy (Ag alloy), copper (Cu) surface-coated with silver (Ag) and silver (Ag) surface-coated with copper (Cu), lithium-nickel-cobalt-manganese-based composite oxides (NCM), lithium-nickel-cobalt-aluminum-based composite oxides (NCA), lithium-cobalt-based composite oxides (LCO), lithium-nickel-based composite oxides (LNO), lithium-manganese-based composite oxides (LMO), lithium iron phosphate (LFP), lithium nickel-cobalt-manganese (NCM), and carbon powder (acetylene black, Super P black, carbon black, Denka black, activated carbon, graphite, hard carbon, soft carbon, etc.).

In addition, the graphene composite may have a network structure formed by connecting the three-dimensional porous graphene structure and the primary microparticles.

In addition, the secondary microparticles may include one or more selected from the group consisting of graphite, graphene, graphene-coated graphite, graphene-coated silicon and silicon, silver (Ag), silicon (Si), silicon carbide (Si₂C, SiC or SiCX including SiC₂), silicon oxide (SiOX including SiO or SiO₂), silicon composite oxide (Si—MgxSiOx), magnesium metasilicate (enstatite, MgSiO₃), forsterite (Mg₂SiO₄), gold (Au), platinum (Pt), palladium (Pd), aluminum (Al), zinc (Zn), silver alloy (Ag alloy), copper (Cu) surface-coated with silver (Ag) and silver (Ag) surface-coated with copper (Cu), lithium-nickel-cobalt-manganese-based composite oxides (NCM), lithium-nickel-cobalt-aluminum-based composite oxides (NCA), lithium-cobalt-based composite oxides (LCO), lithium-nickel-based composite oxides (LNO), lithium-manganese-based composite oxides (LMO), lithium iron phosphate (LFP), and lithium nickel-cobalt-manganese (NCM).

### Advantageous Effects

According to the present disclosure, the negative electrode or positive electrode for the lithium ion battery includes a three-dimensional porous hybrid graphene composite manufactured by a photochemical, photothermal irradiation or thermal treatment process as an active material to form a stable graphene composite structure, significantly improve the charge/discharge rate and efficiency with high electrical conductivity, and maximize a capacity capable of being bound with lithium ions, thereby implementing a lithium ion battery with both performance and stability.

### DESCRIPTION OF DRAWINGS

FIG. 1A is a scanning electron microscope (SEM) photograph and a schematic diagram showing silver particles (Ag) before performing a photothermal irradiation process.

FIG. 1B is a scanning electron microscope (SEM) photograph showing silver particles (Ag) after performing the photothermal irradiation process.

FIG. 1C is a scanning electron microscope (SEM) photograph showing a porous graphene structure (three-dimensional nanoporous graphene) manufactured by photochemical, photothermal irradiation or thermal treatment without metal particles.

FIG. 1D is a scanning electron microscope (SEM) photograph of graphite hybrid graphene composite particles as an embodiment of the present disclosure, which consist of graphite as secondary microparticles and silicon as primary microparticles.

FIG. 1E is a scanning electron microscope (SEM) photograph of a graphene composite consisting of primary microparticles silicon and multilayer graphene, as an embodiment of the present disclosure.

FIGS. 1F and 1G are schematic diagrams and enlarged image photographs of a graphene composite of the present disclosure.

FIG. 2 is a graph showing results of current measurement according to a concentration of electrochemical measuring material (PAP) with respect to each of a hybrid graphene complex electrode (Graphene-Ag electrode), a graphene electrode (Graphene electrode), and a metal electrode (Gold electrode) for a battery active material according to the present disclosure.

FIG. 3 is a graph showing comparison of current values of PAP at the same concentration (10⁻³ mM) with respect to each of a hybrid graphene composite (Hybrid Graphene), graphene (Graphene) and metal (Metal(Au)) for a battery active material according to the present disclosure.

FIG. 4 is a real-time graph showing various concentrations of an electrochemical measuring material (PAP) measured using a hybrid graphene composite particle electrode according to the present disclosure.

FIG. 5, as an example of an all-solid-state battery including a negative electrode for an all-solid-state battery according to the present disclosure,

is a cross-sectional schematic diagram of an all-solid-state battery including a positive electrode including a positive electrode active material (NMC), a sulfide-based solid electrolyte layer, and a negative electrode including a negative electrode current collector (SUS) and a negative electrode active material layer including a negative electrode active material composed of the hybrid graphene composite.

FIG. 6 is a photograph showing cross sections in charging (a) and discharging (b) states of a negative electrode for an all-solid-state battery including hybrid graphene composite particles of the present disclosure.

FIG. 7 is a photograph for a hybrid graphene negative electrode (left) manufactured according to the present disclosure and a coin cell battery (right) manufactured using the hybrid graphene negative electrode.

FIG. 8 is a graph showing battery capacities according to a charge/discharge cycle number when manufacturing a battery negative electrode material using silicon and when manufacturing a battery negative electrode material using silicon particles coated with hybrid graphene of the present disclosure.

### BEST MODE

In describing the present disclosure, the detailed description of known related functions or constitutions will be omitted if it is determined that it unnecessarily makes the gist of the present disclosure unclear.

Embodiments according to a concept of the present disclosure may have various modifications and various forms and specific embodiments will be illustrated in the drawings and described in detail in the present specification or application. However, this does not limit the embodiment according to the concept of the present disclosure to specific embodiments, and it should be understood that the present disclosure covers all the modifications, equivalents and replacements included within the idea and technical scope of the present disclosure.

Terms used in the present specification are used only to describe specific embodiments, and are not intended to limit the present disclosure. A singular expression includes a plural expression unless otherwise defined differently in a context. In the present specification, it should be understood that term “including” or “having” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Hereinafter, the present disclosure will be described in detail.

In a negative electrode of a battery, graphite is stored in the form of LiC₆ (Li+6C=LiC₆) in which lithium is surrounded by six carbon atoms, and silicon is bound with lithium ions to form Li₂₂Si₅ (22Li+5Si=Li₂₂Si₅). After all, six carbon atoms may secure only one lithium ion, whereas five silicon atoms may secure 22 lithium ions, and thus silicon is much more efficient than graphite. Actually, silicon has excellent characteristics with an energy capacity of 4,200 mAh/g, which is about 10 times greater than 372 mAh/g of graphite.

However, a negative electrode material causes a phenomenon (lithiation) in which the volume of the negative electrode increases during the process of storing lithium ions. At this time, while graphite increases in volume by about 10 to 20%, silicon (Si) causes a large volume expansion of 4 to 5 times when 4.4 lithium ions react with one silicon to form a Li₂₂Si₅ alloy. In particular, silicon negative electrode active materials have high crystal breakage. As a result, during repeated charge and discharge, pulverization (cracks and destruction of particles) of the silicon negative electrode active material occurs, and electrical separation from a current collector (Cu electrode plate) occurs, so that a rapid decrease in energy capacity occurs and a lifespan is shortened.

In the present disclosure, silicon primary microparticles are coated with graphene to form a hybrid graphene multilayer structure. Therefore, the expansion of silicon is efficiently suppressed, thereby preventing a phenomenon of breakage caused by changes in the volume of silicon. In addition, the silicon particles are connected with each other by multilayer graphene to also solve a problem of weakening an electrical contact between the particles due to a solid-electrolyte interphase (SEI) that occurs around the silicon particles.

The hybrid graphene, in which the primary microparticles are bound with graphene, encompasses secondary microparticles and fills spaces between the secondary microparticles. As a result, the hybrid graphene electrically connects the primary and secondary microparticles and enables lithium ions to be efficiently bound to the primary and secondary microparticles. Therefore, it is possible to increase a battery life by preventing large volume changes that occur when forming a negative electrode using only silicon primary particles, and increase charging or discharging speeds due to high electrical connectivity.

The present disclosure includes a graphene composite having a structure in which a plurality of primary microparticles and multilayer graphene are mixed, and secondary microparticles encompassed by or coated with the graphene composite, wherein

the primary microparticles are bound to the surface or the inside of the multilayer graphene, and some of the microparticles are bound and solidified with each other,

the multilayer graphene has a three-dimensional structure in which a plurality of layers of graphene are laminated and bent in an arbitrary direction,

the graphene composite is produced by a photochemical, photothermal irradiation or heat treatment process, and

some of empty spaces between the primary microparticles are filled with the graphene composite so that a connected structure is formed.

At this time, since the graphene of the hybrid graphene composite particles has high electron mobility, so that electron supply is uniform and smooth, the graphene serves to increase the charging/discharging speed and efficiency of an all-solid-state battery. In addition, the graphene has a high Young's modulus to efficiently support an expansion phenomenon of the negative electrode active material due to the binding of lithium (Li) and particles such as silicon (Si) particles.

Meanwhile, it is preferred that the graphene constituting the graphene composite is derived from a three-dimensional porous graphene structure rather than pure graphene without defects.

The graphene composite has a three-dimensional structure in which a plurality of layers of graphene are laminated and bent in an arbitrary direction, and the primary microparticles are bound to the surface or the inside of the graphene by photochemical, photothermal irradiation or heat treatment, and some of the micrometal particles are bound and solidified with each other, and

some of empty spaces between the primary microparticles are filled with the graphene composite so that a connected structure is formed.

In addition, the graphene composite may also have a structure in which the graphene is coated on the surface of the primary microparticles.

The hybrid graphene composite particles of the present disclosure have a structure in which the graphene composite is added with secondary microparticles, and as a result, the secondary microparticles encompassed by or coated with the graphene composite are included.

The pure graphene without defects has excellent physical properties such as excellent electrical conductivity and high specific surface area by itself, but an advantage of high specific surface area is greatly reduced due to irreversible self-aggregation.

On the other hand, a three-dimensional porous graphene structure in which pores are organically connected three-dimensionally between single-layer and/or multi-layer graphene sheets has a relatively larger specific surface area due to reduced self-aggregation, and more rapidly diffuses electrons and ions to exhibit relatively superior properties in electrochemical applications such as energy conversion and storage devices. In addition, the three-dimensional porous graphene structure has also an advantage of being able to control pore characteristics (such as location and size of pores, etc.) by controlling process variables during the manufacturing process.

Furthermore, the three-dimensional porous graphene structure may also control the electrical characteristics by changing the electronic structure of graphene through chemical doping that adsorbs heterogeneous materials such as microparticles and the like, like the graphene-primary microparticle composite according to the present disclosure.

Meanwhile, a method for manufacturing hybrid graphene composite particles is not particularly limited, but methods using a hard template or a soft template are mainly used. The methods using the hard template include a method using spherical polymers, a method using metal oxide particles, a method using porous substrates such as nickel foam, and the like, and the soft template methods may synthesize materials with controlled pore sizes by using a micellar template formed by self-assembling surfactant molecules, and has an advantage of relatively easily removing the template compared to the hard template methods.

In addition, the three-dimensional porous graphene structure may also be manufactured by forming a polymer coating layer, and then inducing a stabilization reaction so that carbon atoms in the polymer have a hexagonal ring arrangement, and performing carbonization at a high temperature. At this time, specific examples of the polymer may include poly(methyl methacrylate) (PMMA), polystyrene (PS), polyimide (PI), polyetherimide (PEI), Kapton Film, etc., but are not necessarily limited thereto, and have no special restrictions on the structure, molecular weight, glass transition temperature, etc., as long as the polymer is any polymer that may serve as a carbon source that forms graphene by carbonization at a high temperature.

The primary microparticles constituting the graphene composite to be complexed with the graphene may be microparticles consisting of metal or semiconductor selected from the group consisting of silver (Ag), silicon (Si), silicon carbide (Si₂C, SiC or SiCx including SiC₂), silicon oxide (SiOX including SiO or SiO₂), silicon composite oxide (Si—MgxSiOx), magnesium metasilicate (enstatite, MgSiO₃), forsterite (Mg₂SiO₄), gold (Au), platinum (Pt), palladium (Pd), aluminum (Al), zinc (Zn), silver alloy (Ag alloy), copper (Cu) surface-coated with silver (Ag) and silver (Ag) surface-coated with copper (Cu), lithium-nickel-cobalt-manganese-based composite oxides (NCM), lithium-nickel-cobalt-aluminum-based composite oxides (NCA), lithium-cobalt-based composite oxides (LCO), lithium-nickel-based composite oxides (LNO), lithium-manganese-based composite oxides (LMO), lithium iron phosphate (LFP), lithium nickel-cobalt-manganese (NCM), and carbon powder (acetylene black, Super P black, carbon black, Denka black, activated carbon, graphite, hard carbon, soft carbon, etc.), but are not necessarily limited to the metal particles described above.

As an example of the metal particles, silver (Ag) particles are dissolved in lithium (Li) and lower the energy required for crystallizing lithium to allow lithium to grow more uniformly rather than ununiformly grow by generating pores, thereby ultimately contributing to improved performance of a lithium ion battery.

In addition, the secondary microparticles may include one or more selected from the group consisting of graphite, graphene, graphene-coated graphite, graphene-coated silicon, and silicon, silver (Ag), silicon (Si), silicon carbide (Si₂C, SiC or SiCX including SiC₂), silicon oxide (SiOX including SiO or SiO₂), silicon composite oxide (Si—MgxSiOx), magnesium metasilicate (enstatite, MgSiO₃), forsterite (Mg₂SiO₄), gold (Au), platinum (Pt), palladium (Pd), aluminum (Al), zinc (Zn), silver alloy (Ag alloy), copper (Cu) surface-coated with silver (Ag) and silver (Ag) surface-coated with copper (Cu), lithium-nickel-cobalt-manganese-based composite oxides (NCM), lithium-nickel-cobalt-aluminum-based composite oxides (NCA), lithium-cobalt-based composite oxides (LCO), lithium-nickel-based composite oxides (LNO), lithium-manganese-based composite oxides (LMO), lithium iron phosphate (LFP), and lithium nickel-cobalt-manganese (NCM).

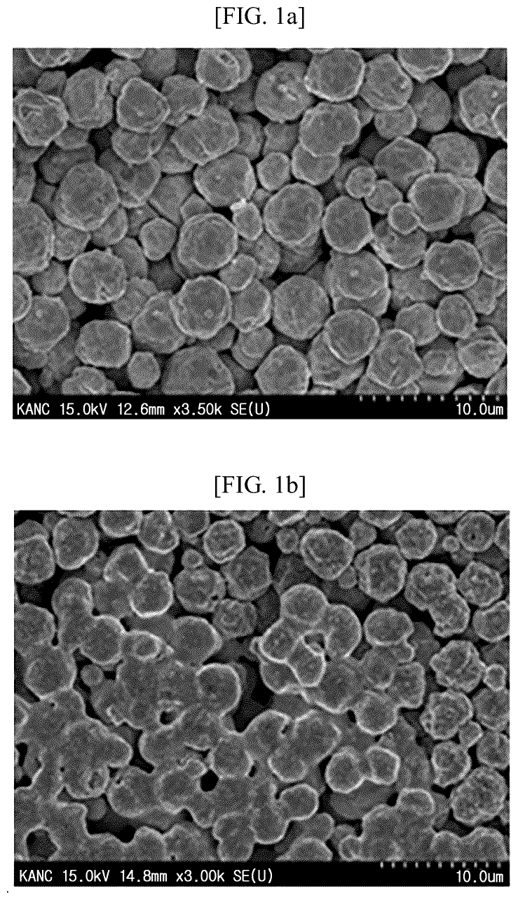

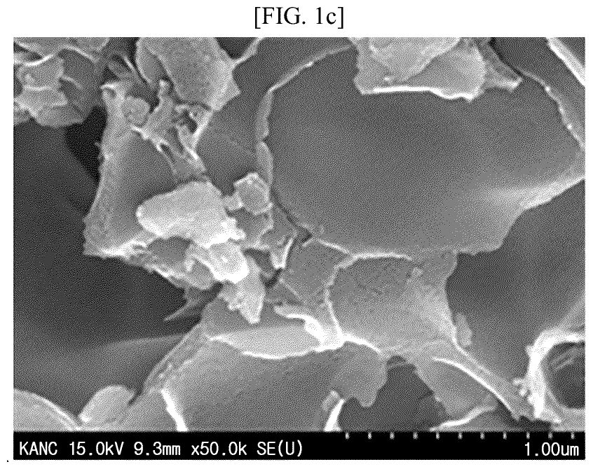

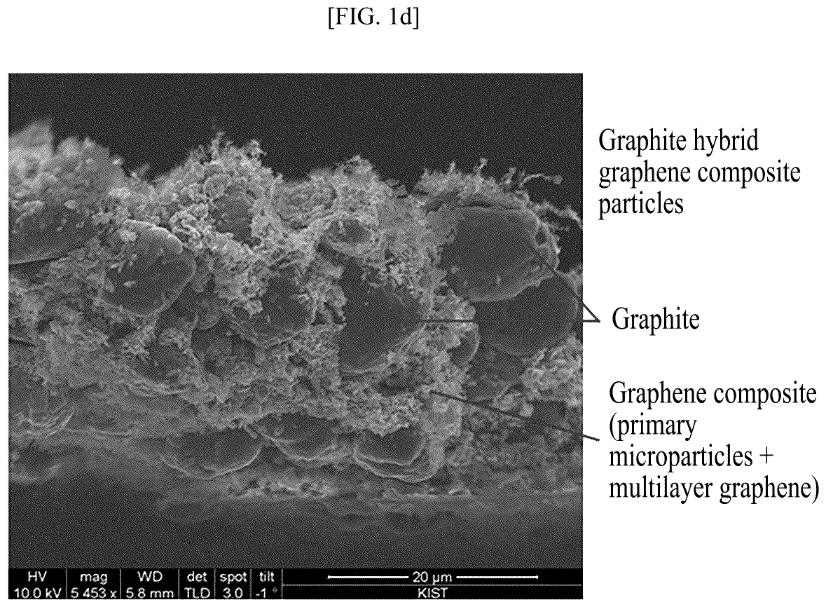

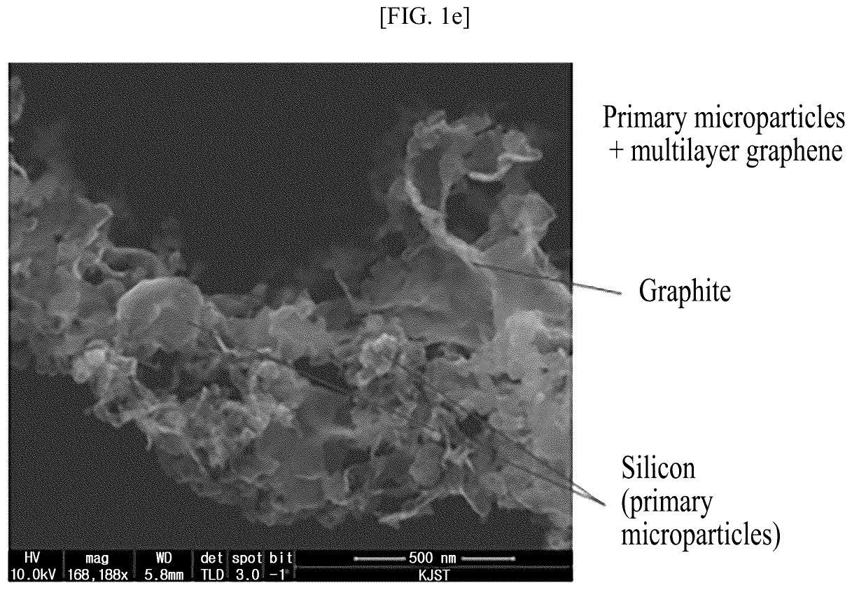

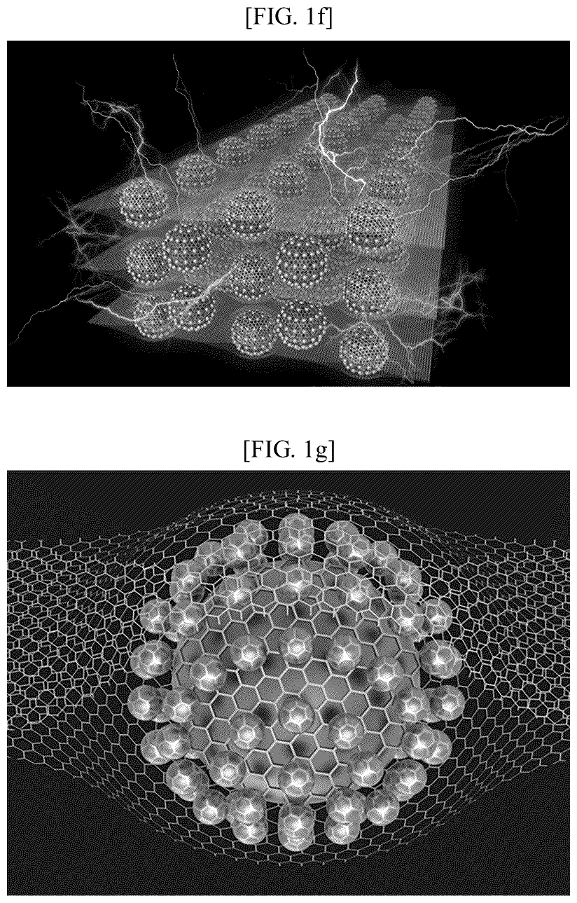

FIG. 1D is a scanning electron microscope (SEM) photograph of graphite hybrid graphene composite particles as an embodiment of the present disclosure, which consist of graphite as secondary microparticles and silicon as primary microparticles.

FIG. 1E is a scanning electron microscope (SEM) photograph of a graphene composite consisting of primary microparticle silicon and multilayer graphene, as an embodiment of the present disclosure.

The secondary microparticles are larger than the primary microparticles and are mainly composed of graphite or silicon particles, and may be replaced with graphene of the graphite size.

Graphite and silicon have similar functions to the primary microparticles and may exhibit excellent electrical conductivity properties depending on a particle size.

As a method for manufacturing the hybrid graphene composite by complexing the graphene and the metal particles, a method of uniformly mixing and complexing a three-dimensional porous graphene structure and metal particles through a stirring process such as ball milling is also possible. More preferably, a hybrid graphene composite may be manufactured by irradiating light such as laser or UV to a mixture in which a three-dimensional porous graphene structure and metal particles are uniformly mixed or sintering the mixture through a heat-treating process to have a three-dimensional network structure in which interconnection between metal particles, interconnection between graphene sheets, and interconnection between metal particles and graphene sheets are organically formed.

The hybrid graphene composite may also be applied to a lithium ion battery of all-solid-state batteries containing a solid electrolyte layer, and the all-solid-state battery including a negative electrode active material composed of the hybrid graphene composite may be formed by including a positive electrode including a positive electrode current collector and a positive electrode active material layer, a solid electrolyte layer, and a negative electrode including a negative electrode current collector and a negative electrode active material layer including a negative electrode active material composed of the hybrid graphene composite.

At this time, the positive electrode active material layer may include at least one positive electrode active material selected from the group consisting of lithium-nickel-cobalt-manganese-based composite oxides (NCM), lithium-nickel-cobalt-aluminum-based composite oxides (NCA), lithium-cobalt-based composite oxides (LCO), lithium-nickel-based composite oxides (LNO), lithium manganese-based composite oxides (LMO), lithium iron phosphate (LFP), lithium nickel-cobalt-manganese (NCM), and carbon powder (acetylene black, Super P black, carbon black, Denka black, activated carbon, graphite, hard carbon, soft carbon, etc.), but the composition material is not necessarily limited to the positive electrode active material.

In addition, the type of solid electrolyte constituting the solid electrolyte layer is not particularly limited, but may include sulfide-based solid electrolytes, and may be, for example, at least one selected from the group consisting of Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂-LiCl, Li₂S—SiS₂—B₂S₃—LiI, Li₂S—SiS₂—P₂S₅—LiI, Li₂S—B₂S₃, Li₂S—GeS₂ and Li₂S—SiS₂—Li₃PO₄.

Hereinafter, the present disclosure will be described in more detail through Examples.

Examples according to the present disclosure may be modified in various different forms, and it is not interpreted that the scope of the present disclosure is limited to the Examples described in detail below.

Examples of the present disclosure will be provided for more completely explaining the present disclosure to those skilled in the art.

FIG. 1A is a scanning electron microscope (SEM) photograph showing silver particles (Ag) before performing a photothermal irradiation process for manufacturing a hybrid graphene composite, which is a negative electrode active material included in a negative electrode for an all-solid-state battery according to the present disclosure.

Referring to FIG. 1A, silver (Ag) particles before photothermal irradiation have a spherical shape and a particle diameter of about 5 μm.

FIG. 1B is a scanning electron microscope (SEM) photograph showing silver particles (Ag) after performing the photothermal irradiation process.

Referring to FIG. 1B, it was confirmed that while the surface of silver (Ag) particles was molten using the photothermal irradiation, the particles were bound and solidified with adjacent particles, and it could be seen that some particles were not connected to form empty spaces.

FIG. 1C is a scanning electron microscope (SEM) photograph showing a porous graphene structure (three-dimensional nanoporous graphene) before performing a photothermal irradiation process for manufacturing a hybrid graphene composite, which is a negative electrode active material included in a negative electrode for a lithium ion battery according to the present disclosure.

Referring to FIG. 1C, it may be confirmed that the multilayer graphene has a structure that is overlapped or bent in a three-dimensional structure.

FIG. 1D is a scanning electron microscope (SEM) photograph of graphite hybrid graphene composite particles as an embodiment of the present disclosure, which consist of graphite as secondary microparticles and silicon as primary microparticles.

FIG. 1E is a scanning electron microscope (SEM) photograph of a graphene composite consisting of primary microparticles silicon and multilayer graphene and an enlarged photograph of only the graphene composite part in FIG. 1D.

The hybrid graphene composite particles of the present disclosure have a structure including a graphene composite having a structure in which a plurality of primary microparticles and multilayer graphene are mixed, and secondary microparticles encompassed by or coated with the graphene composite.

In FIGS. 1D and 1E, the primary microparticles are simultaneously bound to the surface and the inside of the graphene composite by photochemical, photothermal irradiation, or thermal treatment, and at the same time, the primary microparticles are bound and solidified with each other and positioned and fixed in empty spaces.

In addition, the secondary microparticles may include at least one selected from the group consisting of graphite, graphene, graphene-coated graphite, graphene-coated silicon, and silicon, and graphite (FIG. 1D) and silicon (FIG. 1E) may be confirmed as an embodiment of the present disclosure.

Conventional graphene requires complex processes, including a high-temperature process, but synthetic graphene may be synthesized relatively simply through a one-step process through the photochemical, photothermal irradiation, or thermal treatment. FIGS. 1F and 1G are schematic diagrams and enlarged image photographs of a graphene composite of the present disclosure.

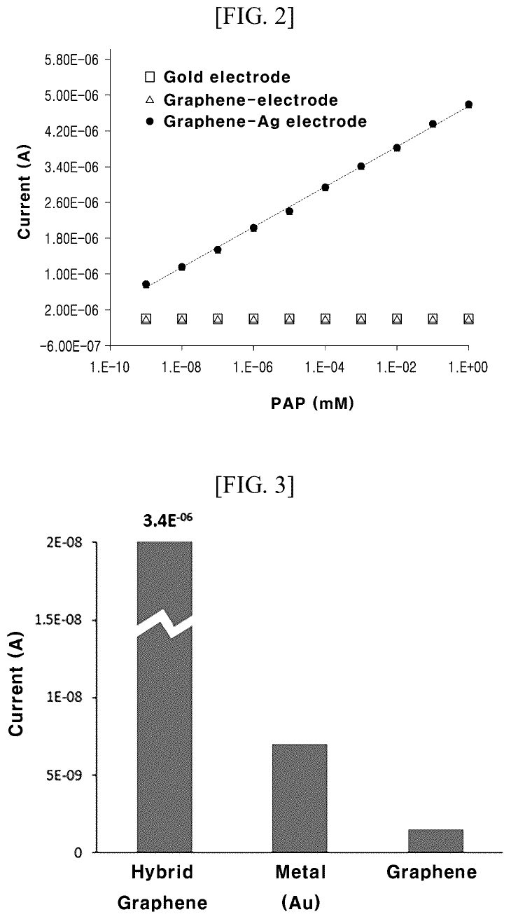

FIG. 2 is a graph showing results of current measurement according to a concentration of an electrochemical measuring material (p-Aminophenol, PAP) with respect to each of a hybrid graphene composite (Graphene-Ag electrode), a graphene electrode (Graphene electrode), and a metal electrode (Gold electrode) for an active material of a battery according to the present disclosure.

For each electrode, the size of a current signal gradually increases depending on a PAP concentration.

In addition, it may be seen that with respect to the same concentration of PAP, a signal of the graphene electrode, which has the advantages of surface area and electron inflow and outflow, is larger than that of the metal electrode, and a signal of the hybrid graphene composite electrode, which has lower resistance than the graphene electrode, is measured to be larger.

FIG. 3 is a graph showing comparison of current values of PAP at the same concentration (10⁻³ mM) with respect to each of a hybrid graphene composite (Hybrid Graphene), graphene (Graphene) and metal (Metal(Au)) for a battery active material according to the present disclosure.

Referring to FIG. 3, a graph shows a difference in current signals measured for the same concentration of PAP with respect to a hybrid graphene electrode (graphene metal composite), a metal electrode and a graphene electrode for a battery active material electrode. It may be seen that the size of the signal measured by the graphene metal composite electrode at the same concentration is much larger than that of comparative electrodes. Therefore, it may be seen that the current signal of the graphene metal composite electrode of the present disclosure generates a larger signal than that of the comparative electrodes, and thus a signal to noise ratio (SNR) is larger than that of the comparative electrodes.

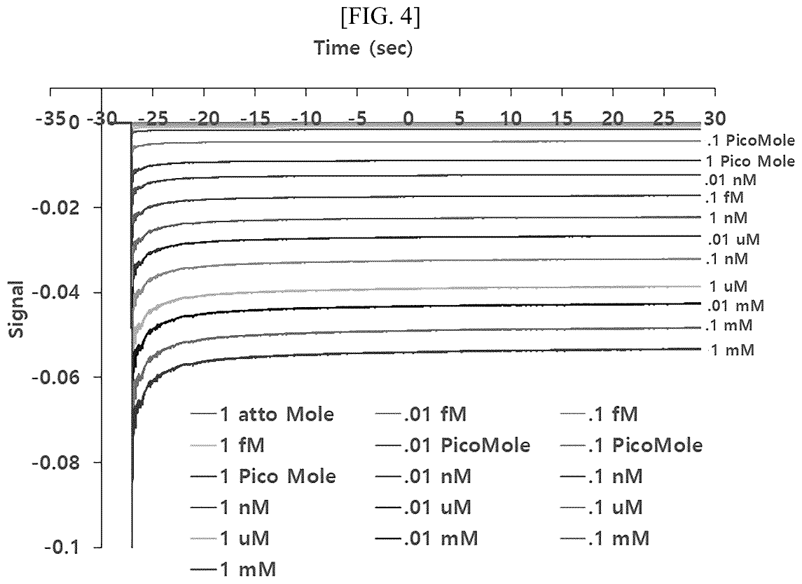

FIG. 4 is a real-time graph showing various concentrations of an electrochemical measuring material (PAP) measured using a hybrid graphene composite particle electrode according to the present disclosure.

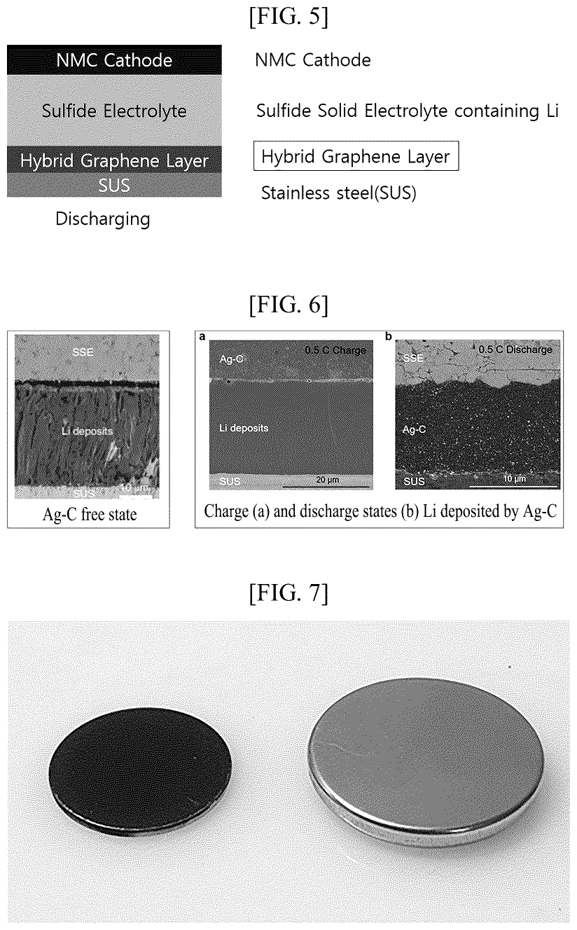

FIG. 5, as an example of an all-solid-state battery including a negative electrode for an all-solid-state battery according to the present disclosure, is a cross-sectional schematic diagram of an all-solid-state battery including a positive electrode including a positive electrode active material (NMC), a sulfide-based solid electrolyte layer, and a negative electrode including a negative electrode current collector (SUS) and a negative electrode active material layer including a negative electrode active material composed of the hybrid graphene composite.

FIG. 6 is a photograph showing cross sections in charging (a) and discharging (b) states of a negative electrode for an all-solid-state battery including a hybrid graphene composite of the present disclosure.

Conventional negative electrodes have a problem that lithium is ununiform and pores are generated to be deposited in the form of dendrites, but silver micrometal particles are dissolved in lithium and lower energy required for lithium to be crystallized, thereby allowing lithium to grow uniformly. In addition, graphene prevents lithium metal from growing and coming into direct contact with a solid electrolyte, thereby preventing the solid electrolyte from being decomposed and improving durability life.

The graphene serves as a three-dimensional host in which lithium metal is deposited and as a protective layer that protects the solid electrolyte to improve the durability.

FIG. 7 shows a hybrid graphene negative electrode (left) manufactured according to the present disclosure and a coin cell battery (right) manufactured using the hybrid graphene negative electrode.

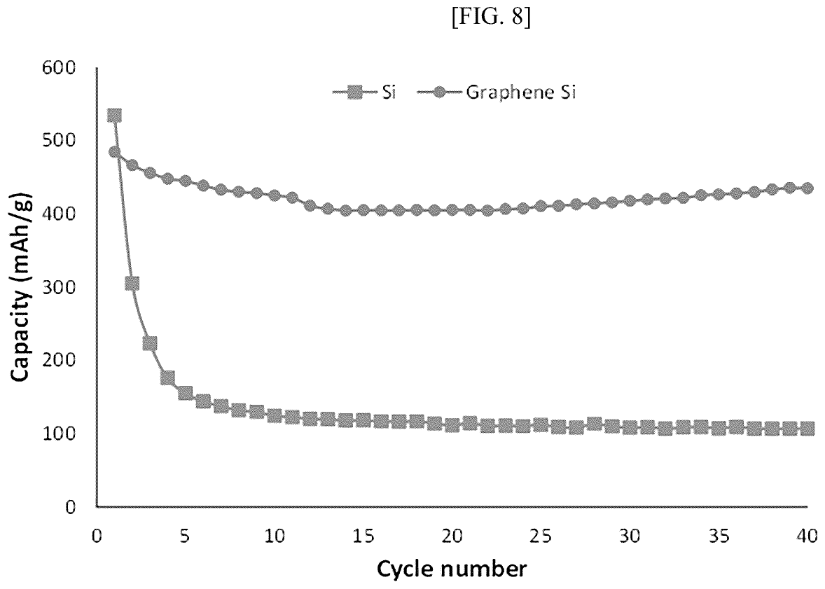

FIG. 8 is a graph showing battery capacities according to a charge/discharge cycle number when manufacturing a battery negative electrode material using silicon and when manufacturing the battery negative electrode material using silicon particles coated with hybrid graphene of the present disclosure. When manufacturing the battery negative electrode material using silicon, the electrical connection between the particles decreases due to changes in the volume of silicon and the formation of Solid Electrolyte Interphase (SEI), so that the battery capacity decreases rapidly as charging and discharging are repeated. On the other hand, in the case of graphene-coated silicon, the volume expansion of silicon is suppressed by graphene, and even if SEI is formed, the particles are electrically connected with each other by graphene, so that the capacity reduction is very small. As a result, when manufacturing a battery using silicon coated with the graphene of the present disclosure, it is possible to manufacture a battery that may significantly increase its capacity and have a long lifespan by silicon.

As described above, the present disclosure is not limited to the aforementioned embodiments and the accompanying drawings, and it will be obvious to those skilled in the technical field to which the present disclosure pertains that various substitutions, modifications, and changes may be made within the scope without departing from the technical spirit of the present disclosure.

1. Hybrid graphene composite particles comprising a graphene composite having a structure in which a plurality of primary microparticles and multilayer graphene are mixed, and secondary microparticles encompassed by or coated with the graphene composite, wherein
the primary microparticles are bound to the surface or the inside of the multilayer graphene, and
some of empty spaces between the primary microparticles are filled with the graphene composite so that a connected structure is formed.

2. The hybrid graphene composite particles of claim 1, wherein the surface of the primary or secondary microparticles is coated with graphene.

3. The hybrid graphene composite particles of claim 1, wherein the graphene composite is produced by a photochemical, photothermal irradiation or heat treatment process.

4. The hybrid graphene composite particles of claim 1, wherein the primary microparticles are metal or semiconductor particles.

5. The hybrid graphene composite particles of claim 1, wherein while the surface of the primary microparticles is molten and solidified with graphene, the microparticles and graphene form a three-dimensional nanostructure and are bonded to each other.

6. The hybrid graphene composite particles of claim 1, wherein the primary microparticles consist of metal or semiconductor selected from the group consisting of silver (Ag), silicon (Si), silicon carbide (Si₂C, SiC or SiCX including SiC₂), silicon oxide (SiOX including SiO or SiO₂), silicon composite oxide (Si—MgxSiOx), magnesium metasilicate (enstatite, MgSiO₃), forsterite (Mg₂SiO₄), gold (Au), platinum (Pt), palladium (Pd), aluminum (Al), zinc (Zn), silver alloy (Ag alloy), copper (Cu) surface-coated with silver (Ag) and silver (Ag) surface-coated with copper (Cu), lithium-nickel-cobalt-manganese-based composite oxides (NCM), lithium-nickel-cobalt-aluminum-based composite oxides (NCA), lithium-cobalt-based composite oxides (LCO), lithium-nickel-based composite oxides (LNO), lithium-manganese-based composite oxides (LMO), lithium iron phosphate (LFP), lithium nickel-cobalt-manganese (NCM), and carbon powder (acetylene black, Super P black, carbon black, Denka black, activated carbon, graphite, hard carbon, soft carbon, etc.).

7. The hybrid graphene composite particles of claim 1, wherein the graphene composite has a network structure formed by connecting the three-dimensional porous graphene structure and the primary microparticles.

8. The hybrid graphene composite particles of claim 1, wherein the secondary microparticles include one or more selected from the group consisting of graphite, graphene, graphene-coated graphite, graphene-coated silicon, and silicon, silver (Ag), silicon (Si), silicon carbide (Si₂C, SiC or SiCX including SiC₂), silicon oxide (SiOX including SiO or SiO₂), silicon composite oxide (Si—MgxSiOx), magnesium metasilicate (enstatite, MgSiO₃), forsterite (Mg₂SiO₄), gold (Au), platinum (Pt), palladium (Pd), aluminum (Al), zinc (Zn), silver alloy (Ag alloy), copper (Cu) surface-coated with silver (Ag) and silver (Ag) surface-coated with copper (Cu), lithium-nickel-cobalt-manganese-based composite oxides (NCM), lithium-nickel-cobalt-aluminum-based composite oxides (NCA), lithium-cobalt-based composite oxides (LCO), lithium-nickel-based composite oxides (LNO), lithium-manganese-based composite oxides (LMO), lithium iron phosphate (LFP), lithium nickel-cobalt-manganese (NCM), and carbon powder (acetylene black, Super P black, carbon black, Denka black, activated carbon, hard carbon, soft carbon, etc.).
